(19) United States
(12) Patent Application Publication
(10) Pub. No.: US 2016/0318024 A1
(43) Pub. Date: Nov. 3, 2016

(54) HARD BODY AS GRID ARMORING FOR A ROLLER PRESS, A METHOD FOR ITS PRODUCTION, AND A ROLLER FOR A ROLLER PRESS

(71) Applicant: TAKRAF GmbH, Leipzig (DE)

(72) Inventors: Meinhard FRANGENBERG, Kurten-Engeldorf (DE); Karsten EBENHAN, Dresden (DE)

(73) Assignee: TAKRAF GmbH, Leipzig (DE)

(21) Appl. No.: 15/142,123

(22) Filed: Apr. 29, 2016

(30) Foreign Application Priority Data
Apr. 29, 2015 (DE) 10 2015 207 922.8

(51) Int. Cl. B02C 4/30

(52) U.S. Cl. CPC B02C 4/305; B02C 4/02

(57) ABSTRACT

The wear-resistant hard body according to the invention consists, at least partially, of a high-strength, iron-based alloy (IFW), and preferably comprises an external shell or sleeve made of another material. Roller press rollers usually have a bandage, often referred to as a roller body, in which the hard bodies are inserted as grid armoring.

Particularly preferably, the hard body has a trilaterally closed, external shell. Advantageously, the hard body thus hardly needs any processing to ensure that it fits into the hole in the bandage, as the shell already does. Thus, a defined fit between the bandage and the shelled hard body is made possible. The hard bodies according to the invention with a shell or a sleeve are also referred to as bimetallic studs.

Particularly preferably, the wear-resistant hard bodies furthermore have a circular cylindrical shape. Here, the closed front end of the shell, which in the installed state faces the center of the roller, is preferably shaped in a rounded fashion. Advantageously, cracking of the bandage due to sharp edges is thus prevented. Especially preferably, the rounding is a spherical shape.

The invention relates to a hard body for the grid armoring for a roller of a roller press, a method for its production, and a roller for a roller press.

A roller press, also referred to as a material-bed grinding roll, has two rollers between which a bed of material is comminuted by means of a high pressure. The high pressure thereby causes high wear of the rollers. Various solutions have been proposed to reduce this wear.

In principle, surface profiling of rollers is acknowledged to be wear-reducing, whereby profiling may be applied in a number of ways. For example, EP 0443195 A1 proposes the application of burls on the roller surface by welding.

DE 10 2010 024 221 A1 proposes a bandage for a roller press consisting of a high-chromium ferrous alloy. The bandage is formed with a profiled external surface to improve wear protection. Besides the high costs of the alloy, applying the bandage is a complicated process step, resulting in high total costs.

DE 41 32 474 A1 proposes that wear-resistant pieces of material, which are harder than the surrounding rolling material, be embedded in the roller surface. The material pieces are preferably plate- or pin-shaped, connected to the roller by means of bonding and made of carbide. The cost of the carbide material pieces is high, which is a disadvantage, and moreover, carbide is too wear-resistant and brittle for various application purposes.

Document EP 2239058 A2 discloses a wear-resistant roller and its production. The roller includes a plurality of wear-resistant surface elements, preferably bolts, the free bolt ends protruding radially from the surface of the roller. The spaces between the bolts are filled with a matrix material that is softer than the bolts and ground material is refilled on [top of] the matrix material. The bolts are welded on the roller and consist, at least partially, of a high-strength ferrous alloy. A disadvantage is the complex and costly manufacturing process for the device.

DE 10 2011 104 854 A1 proposes to place the hard bodies in a sleeve and insert them into the roller surface. This allows for the hard bodies to be released from the roller surface in an easier way.

The problem of the present invention is to propose an alternative grid armoring for a roller of a roller press that is inexpensive and has a long service life.

According to the invention, this problem is solved by a wear-resistant hard body according to claim 1, a roller for a roller press according to claim 11, by a method of producing a hard body according to claim 15, and by implementing claim 17. Preferred developments of the invention are the subject matter of the dependent claims.

The wear-resistant hard body according to the invention consists, at least partially, of a high-strength, iron-based alloy (IFW), and comprises an external shell or sleeve made of another material. Roller press rollers usually have a bandage, often referred to as a roller body, in which the hard bodies are inserted as grid armoring.

Particularly preferably, the hard body has a trilaterally closed external shell. As an advantage, the hard body therefore hardly needs any processing in order to ensure that it fits into the hole in the bandage, as the shell already does. Thus, a defined fit between the bandage and the shelled hard body is made possible. The inventive hard bodies with a shell or a sleeve are also referred to as bimetallic studs.

Particularly preferably, the wear-resistant hard bodies furthermore have a circular cylindrical shape. The closed front end of the shell, which in the installed state is facing the center of the roller, is thereby preferably shaped in a rounded fashion. Advantageously, cracking of the bandage caused by sharp edges is thus prevented. Especially preferably, the rounding has a spherical shape.

In the context of this patent application, the high-strength, iron-based alloy (IFW) is understood to be a high-strength ferrous alloy consisting of a material of the compound according to the formula Feₐ E1_{b} E2_{c} E3_{d} E4ₑ. Here, E1 represents one or more elements of the group Cr, V, Mn, Co and Ni, E2 represents one or more elements of the group Mo, Nb, Zr, Y, Hf, Ti, Ta, and W, E3 represents one or more elements of the group Sn , Al, Ga, Pb, and E4 represents one or more elements of the group Si, P, C and B, where a=100−(b+c+d+e) b=1 to 12, c=1 to 12, d=0 to 12, e=1 to 25 (a, b, c, d, e in atom %). Small amounts of additives and contaminants may thereby be contained as a result of the manufacturing process. 30-90 vol % of the structure of the molded bodies produced from an alloy consists of at least one microcrystalline austenitic, cubic, face-centered (cfc) phase, containing at least one additional microcrystalline phase. The alloy according to the invention is described in DE 10 2006 024 358. The hard bodies are preferably produced by casting into the shell or sleeve made of another material, preferably copper, copper alloys or steel.

Especially advantageous material properties can be achieved, when the hard bodies are produced according to the process described in DE 10 2010 062 011 B3. This process stipulates that after mixing of the alloying elements and their melting, they are poured into a mold, which allows for a cooling rate of at least 10 K/s. Subsequently, the material is tempered at least twice in immediate succession, at tempering temperatures between 500° C. and 600° C., and holding times between 30 seconds and 15 minutes during tempering. The heating and cooling rates should be at least 15 K/min.

In a further preferred embodiment, the shell of the hard body has means allowing for a mounting structure, such as welding lugs or a thread. Advantageously, the hard body can be safely mounted in the roller or at the roller edges. Such a mounting structure would be difficult to realize on a hard body. Other options include a recess or circumferential groove for introducing an annular spring. Such a hard body would be removable by welding on a tab, or the like, for a slide hammer. After driving a hard body into the hole of the roller, the spring produces a force-locking connection. More preferably, the shell comprises a profiling of the external surface of the hard body, allowing the roller to be press-fitted into the roller of the roller press, similar to a grooved pin.

Moreover, the hard bodies preferably have a core made of a weldable material, especially steel, which makes it possible to weld on a means for facilitating the removal of the hard body from the roll.

Preferably, between the shell and/or sleeve and the part of the hard body contained therein, a form-fitting connection is present. This will prevent the shell from releasing due to large temperature fluctuations or other effects.

A recess in the outer casing of the shell or sleeve, in particular at the front end of the hard body, which in the installed state is facing the center of the roller, is likewise preferable. The recess allows venting of the cavity during insertion into the narrow tolerances of the mounting hole of the roller tube, thereby facilitating the introduction of the roller tube into the holes.

As an alternative to press fitting, the wear-resistant hard bodies are adhesively bonded in the holes of the roller. The use of a shell or a sleeve makes it possible to achieve a defined bonding gap. An adhesive reservoir often forms at the bottom of the hole, which has an adverse hydraulic effect. Bonding also unnecessarily prolongs the manufacturing process, as the hard bodies can be bonded only after shrink-fitting of the bandage, or else the adhesive might burn. Finally, omitting an adhesive is environmentally friendly. At any rate, the adhesive compound is crushed during the initial rotation of the rollers.

The high tolerances during the machining of hard bodies cause the formation of a large bonding nip or a negative allowance, through which the hard bodies can be press-fitted only with great force, when bonding on the roller without the shell or sleeve.

Particularly preferred is the high-strength ferrous alloy (IFW) FeCrMoVC. The benefit of this material is primarily the advantageous combination of great hardness and strength, combined with a high ductility. Thus, a high resistance to abrasive and impact stresses can be expected. Furthermore, this material affords the option of becoming independent of tungsten, a strategic material, and reducing the costs, while also reducing the production effort.

The inventive roller for a roller press has at least one of the above-described hard bodies as grid armoring.

In a preferred embodiment, the roller press roller comprises side-wear protection elements, which are likewise made of a high-strength, iron-based alloy (IFW). Side-wear protection elements are then armoring elements in the area of the transition from the outer surface to the front end of the roller. It may also be advantageous to design the mold, such that it allows for a mounting structure, e.g., welding or a thread, which is difficult to realize on a hard body, in order to securely fasten this structure on the roller edges.

The inventive method relates to primary shaping of the wear-resistant hard bodies. Here, primary shaping of the wear-resistant hard bodies is done in a closed shell or sleeve, as a mold. For this purpose, the mold is inserted into a preferably cooled casting enclosure and subsequently filled with the molten alloy. The shell preferably has a circular cylindrical cross-section with a hemispherical end. Moreover, the casting enclosure of the mold is preferably divided, which makes it easier to remove the workpiece in an advantageous fashion.

Moreover, the exterior of the cast shell, i.e., with a circular cross-sectional shape of the outer diameter, preferably matches the fit of the wear-resistant hard bodies in the bandage of the roller. Advantageously, reworking of the wear-resistant hard bodies following primary shaping, which is highly complex due to the materials properties, can thus largely be omitted.

Various embodiments of the invention are explained below with reference to the figures. What is shown:

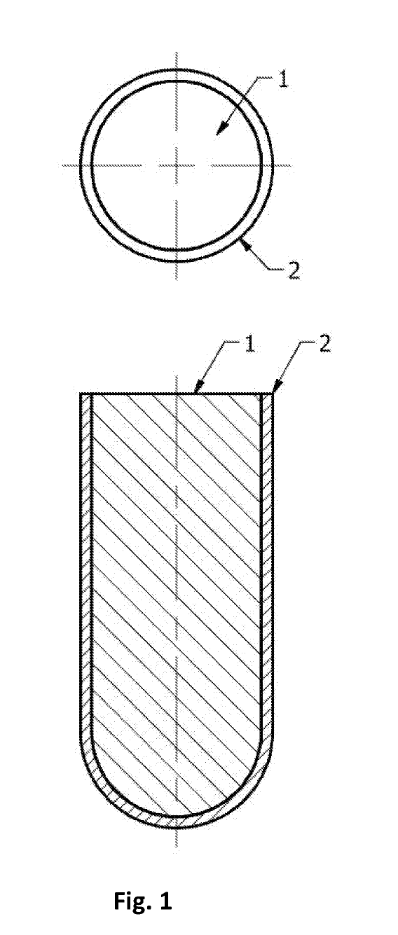

FIG. 1 A hard body according to the invention comprising a shell;

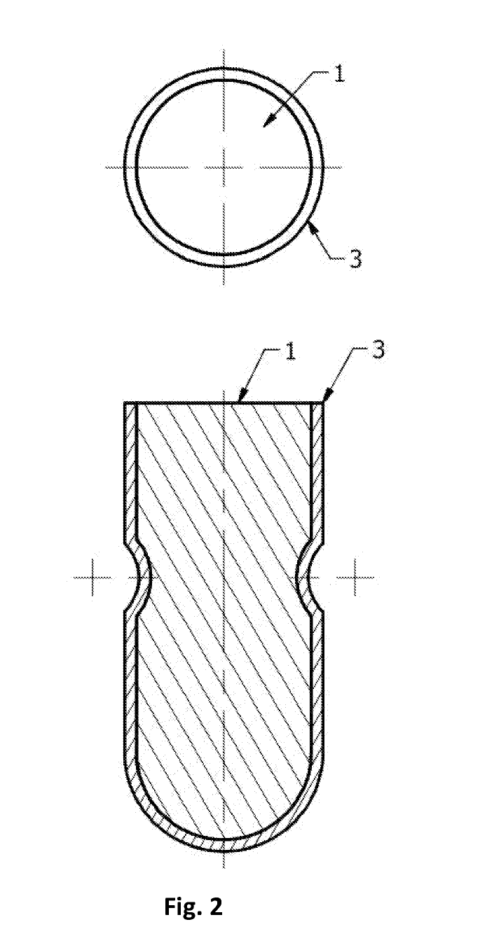

FIG. 2 A hard body according to the invention comprising a shell and a taper;

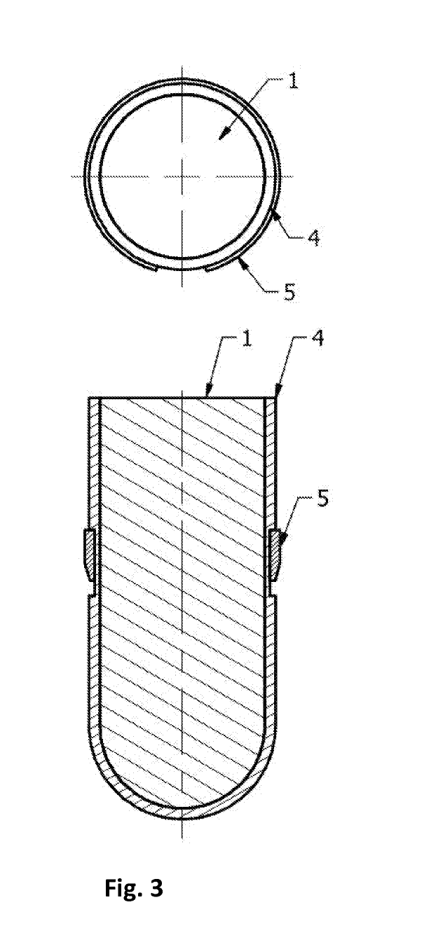

FIG. 3 A hard body according to the invention comprising a shell and an annular spring; and

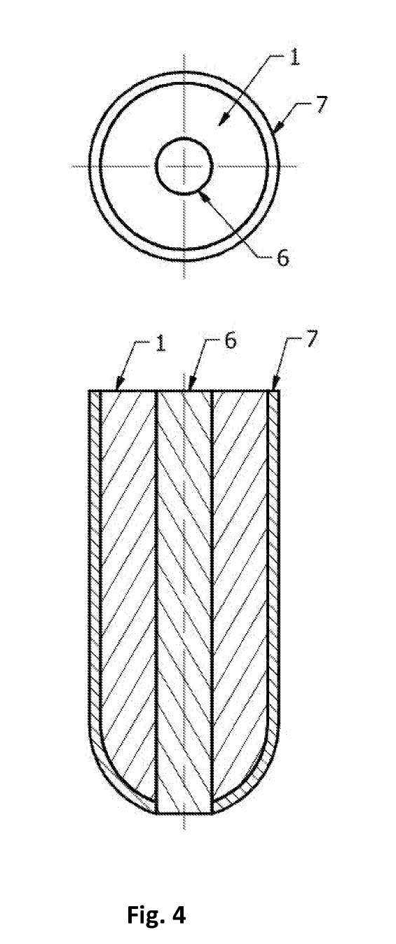

FIG. 4 A hard body according to the invention comprising a steel core.

FIG. 1 shows a hard body 1 according to the invention made of a high-strength, iron-based alloy, i.e., FeCrMoVC in a unilaterally closed, hollow cylindrical shell 2 made, e.g., of copper. For the manufacture of the hard body 1, the shell 2 is placed in a two-section, coolable housing and the enclosure closed. The melt of the alloy according to the invention FeCrMoVC is then filled with the alloy FeCrMoVC inside the enclosure 1, 2. This is followed by annealing, whereby the hard body 4 is heated twice in succession in the shell 2 for 10 minutes to a temperature of 600° C.

FIG. 2 shows a hard body 1 according to the invention with a shell 3 incorporating a taper. The tapering provides a positive locking fit of the hard body 1 in the shell 3, whereby the hard body can be prevented from falling out of the shell. 3

FIG. 3 likewise shows a hard body 1 according to the invention with a shell 4 comprising a circumferential annular groove in which an annular spring 5 is arranged. The annular spring 5 is able to prevent the release of the shell 4 from the roller bandage. To remove a hard body 1 with a shell 4 with an annular spring 5, a tab is welded onto the shell 4 and the hard body 1 is extracted at this tab with a slide hammer.

FIG. 4 shows a hard body 1 with an inner core 6 made of steel. This core 6 allows for easy removal, in that a means may be welded onto the core 6, whereby the hard body 1 along with shell 7 may be extracted from the roller bandage in a simple fashion.

### REFERENCE NUMERAL LIST

1 Hard body
2 Shell
3 Shell with a taper
4 Shell with a circumferential groove
5 Annular spring
6 Core
7 Bilaterally opened shell

1. A hard body (1) as grid armoring for a roller of a roller press, characterized in that the hard body (1) consists at least partially of a high-strength, iron-based alloy (IFW) and comprises a shell (2) or sleeve made of another material, in particular steel, copper or a copper alloy on the outer surface.

2. A hard body (1) as grid armoring for a roller of a roller press according to claim 1, characterized in that the hard bodies (1) have a circular cylindrical shape, wherein the front end of the hard body (1) facing the middle of the roller has a conical or rounded shape.

3. A hard body (1) as grid armoring for a roller of a roller press according to claim 2, characterized in that the shell (2) is a unilaterally closed hollow cylinder with a circular cross section and the closed front end is formed hemispherically.

4. A hard body (1) as grid armoring for a roller of a roller press according to claim 3, characterized in that the shell (3) has an internal projection, such that between the shell (3) and the hard body (1), a positive fit connection is created.

5. A hard body (1) as grid armoring for a roller of a roller press according to one of claim 3 or 4, characterized in that the shell (4) externally has a slot for an external annular spring (5).

6. A hard body (1) as grid armoring for a roller of a roller press according to one of claims 3 to 5, characterized in that the shell (4) comprises a recess on its closed front end.

7. A hard body (1) as grid armoring for a roller of a roller press according to one of claims 3 to 6, characterized in that the hard body (1) axially and centrally has a core made of a weldable material.

8. A hard body (1) as grid armoring for a roller of a roller press according to one of the preceding claims, characterized in that the shell (2) or sleeve has an external profiling.

9. A hard body (1) as grid armoring for a roller of a roller press according to one of the preceding claims, characterized in that the high-strength ferrous alloy is FeCrMoVC.

10. A roller for a roller press comprising at least one hard body (1) according to one of the preceding claims.

11. A roller for a roller press according to claim 10, characterized in that the wear-resistant hard bodies (1) are adhesively bonded into holes in the bandage of the roller that fit.

12. A roller for a roller press according to claim 10, characterized in that the wear-resistant hard bodies (1) are pressed into the holes in the bandage of the roller.

13. A roller for a roller press according to one of claims 10 to 12, characterized in that the roller comprises side-wear protection elements implemented as hard bodies (1) made of a high-strength ferrous alloy (IFW).

14. A method for producing a wear-resistant hard body (1) according to one of claims 2 to 9, characterized in that in order to mold the hard body (1), a shell or sleeve is placed in a divided casting enclosure, into which the alloy melt is filled.

15. A method for producing a wear-resistant hard body (1) according to claim 14, characterized in that the casting enclosure is liquid-cooled.

16. The use of a high-strength, iron-based alloy (IFW) for the production of hard bodies (1) or side-wear protection elements for the roller of a roller press.
